(19) United States
(12) Patent Application Publication
(10) Pub. No.: US 2026/0186496 A1
(43) Pub. Date: Jul. 2, 2026

(54) Method of Controlling Automated Guided Vehicle, Automated Guided Vehicle and System

(71) Applicant: ABB Schweiz AG, Baden (CH)

(72) Inventor: Jonas Larsson, Västerås (SE)

(73) Assignee: ABB Schweiz AG, Baden (CH)

(21) Appl. No.: 19/546,858

(22) Filed: Feb. 23, 2026

Related U.S. Application Data
(63) Continuation of application No. PCT/EP2023/075021, filed on Sep. 12, 2023.

(51) Int. Cl. G05D 1/611; G05D 1/229; G05D 109/18; G05D 111/50

(52) U.S. Cl. CPC G05D 1/611; G05D 1/229; G05D 2109/18; G05D 2111/50

(57) ABSTRACT

A method of controlling an AGV, which includes a support structure and at least three wheel units, each comprising a wheel rotatable around a horizontal wheel axis; wherein for at least two of the wheel units, the wheel unit comprises a steering motor; and wherein the method comprises providing a support point and an application load comprising an application force in relation to the support structure; representing the application load by a remote force acting at a remote point horizontally offset from the support point, and in a horizontal remote direction transverse to an offset line; and for the at least two of the wheel units comprising a steering motor, positioning each wheel in a steering position such that an instant center of rotation (ICR) of each wheel substantially coincides with the remote point.

### CROSS-REFERENCE TO RELATED APPLICATIONS

The instant application claims priority to International Patent Application No. PCT/EP2023/075021, filed Sep. 15, 2023, which is incorporated herein in its entirety by reference.

### FIELD OF THE DISCLOSURE

The present disclosure generally relates to automated guided vehicles (AGVs) and, more particularly, to a method of controlling an AGV, an AGV, and a system comprising an AGV.

### BACKGROUND OF THE INVENTION

Automated guided vehicles, AGVs, are typically self-powered, self-driven vehicles. AGVs may be used to transport materials and other items from one location to another, without the need for a driver on the vehicle. An AGV may also comprise a manipulator for performing various tasks. AGVs are commonly used in manufacturing sites, warehouses, post offices, libraries, port terminals, airports, and some hazardous locations and specialty industries.

WO 2020259830 A1 discloses a method of braking an AGV. The AGV comprises a support structure and at least three drive units connected to the support structure. The method comprises positioning wheels of the drive units in an invalid configuration, and position controlling each wheel about a respective steering axis in the invalid configuration. Although the method in WO 2020259830 A1 provides a good universal solution for braking the AGV, the invalid wheel configuration is not adapted to any specific loads.

If an AGV comprising a manipulator is instructed to be at standstill while performing a task using the manipulator, there is a risk that the task fails if a support structure of the AGV moves (e.g., translationally moves and/or rotates) even slightly. In order to account for such risk, the manipulator may only carry out relatively simple low accuracy tasks and at low speeds, frequent recalibrations of the AGV may be required, and/or interactions between the manipulator and its environment, such as pushing operations, may be avoided. All these measures limit the productivity of the AGV. The manipulator may also be prevented from performing more complicated tasks when the stability of the support structure is not ensured. The use of dedicated brakes to hold the support structure at standstill significantly increases the cost of the AGV.

### BRIEF SUMMARY OF THE INVENTION

The present disclosure generally describes an improved method of controlling an automated guided vehicle (AGV), an improved AGV, and/or an improved system. In one general aspect, by representing an application load on an AGV by a remote force acting at a remote point, and by orienting wheels of the AGV such that an instant center of rotation, ICR, thereof coincides with the remote point, an increased stiffness of the AGV can be obtained.

According to a first aspect, there is provided a method of controlling an automated guided vehicle, AGV, the AGV comprising a support structure and at least three wheel units, each wheel unit comprising a wheel rotatable around a horizontal wheel axis; wherein for at least two of the wheel units, the wheel unit comprises a steering motor arranged to drive the wheel around a vertical steering axis; and wherein the method comprises providing a support point in relation to the support structure; providing an application load in relation to the support structure, the application load comprising an application force; representing the application load by a remote force acting at a remote point horizontally offset from the support point, and acting in a horizontal remote direction transverse to an offset line between the support point and the remote point; and for the at least two of the wheel units comprising a steering motor, positioning each wheel in a steering position such that an instant center of rotation, ICR, of each wheel substantially coincides with, or coincides with, the remote point.

### BRIEF DESCRIPTION OF THE SEVERAL VIEWS OF THE DRAWING(S)

FIG. 1 is a side view of a system comprising an automated guided vehicle (AGV), in accordance with the disclosure.

FIG. 2 is a diagram of a cross-sectional side view of one example of a drive unit for the AGV, in accordance with the disclosure.

FIG. 3 is a diagram of a top view of the AGV when an application load is applied to a support structure of the AGV, in accordance with the disclosure.

FIG. 4 is a diagram of a top view of the AGV when each wheel of the AGV is positioned at a steering position such that an instant center of rotation, ICR, coincides with a remote point, in accordance with the disclosure.

FIG. 5 is a diagram of a top view of the AGV when some of the wheels are positioned at a respective steering position such that an ICR of these wheels coincides with the remote point, in accordance with the disclosure.

FIG. 6 is a diagram of schematically represents a top view of the AGV when some of the wheels are positioned at a respective steering position such that an ICR of these wheels coincides with the remote point, in accordance with the disclosure.

FIG. 7 is a diagram of a top view of the AGV when each wheel is positioned at a steering position such that an ICR of these wheels coincides with another remote point, in accordance with the disclosure.

FIG. 8 is a diagram of a top view of a further example of an AGV when some of the wheels of the AGV are positioned at a respective steering position such that an ICR of these wheels coincides with another remote point, in accordance with the disclosure.

FIG. 9 is a flowchart outlining general steps of a method, in accordance with the disclosure.

### DETAILED DESCRIPTION OF THE INVENTION

In the following, a method of controlling an automated guided vehicle, AGV, an AGV and a system comprising an AGV, will be described. The same or similar reference numerals will be used to denote the same or similar structural features.

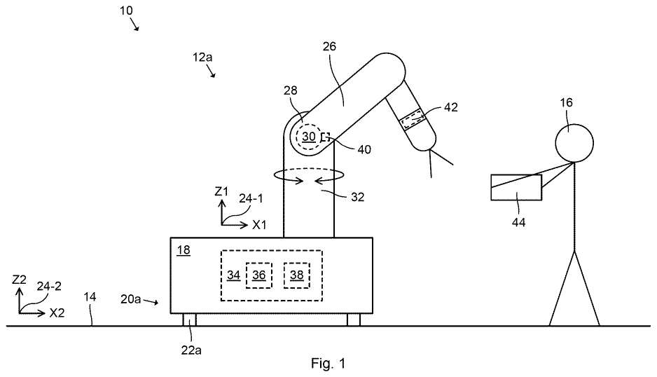

FIG. 1 schematically represents a side view of a system 10. The system 10 comprises an automated guided vehicle 12a, AGV. The system 10 may thus be referred to as an AGV system. In FIG. 1, the AGV 12a is positioned on a horizontal ground surface 14, here exemplified as a floor. FIG. 1 further shows a human user 16 next to the AGV 12a.

The AGV 12a comprises a support structure 18, here exemplified as a platform. The AGV 12a of this example further comprises four wheel units 20a (only two are visible in FIG. 1) connected to the support structure 18. Each wheel unit 20a comprises a wheel 22a. Each wheel 22a is arranged to support the support structure 18 on the ground surface 14. The AGV 12a may further comprise a power source (not shown), such as a battery, to power the wheel units 20a.

FIG. 1 further shows a local coordinate system 24-1 and a global coordinate system 24-2. In this example, the local coordinate system 24-1 is fixed with respect to the support structure 18 and the global coordinate system 24-2 is fixed with respect to the ground surface 14.

The AGV 12a of this example further comprises a manipulator 26, here exemplified as a serial robot arm programmable in at least three axes. The manipulator 26 is supported on the support structure 18 and is movable relative to the support structure 18.

The manipulator 26 of this example comprises plurality of joints 28, a plurality of actuators 30 for driving respective joints 28, and a plurality of links, including a first link 32. The first link 32 is rotatable relative to the support structure 18 around a vertical axis as shown with a corresponding arrow.

The AGV 12a further comprises an electronic control system 34 configured to control the AGV 12a. The control system 34 of this example comprises a data processing device 36 and a memory 38. The memory 38 has a computer program stored therein. The computer program comprises program code which, when executed by the data processing device 36, causes the data processing device 36 to perform, or command performance of, various steps as described herein. An AGV control program is also stored in the memory 38. When the AGV control program is executed, the AGV 12a is controlled to perform various tasks. The AGV control program may comprise movement instructions for the AGV 12a. The movement instructions may comprise instructions which, when executed, causes the AGV 12a to move over the ground surface 14, and movement instructions which, when executed, causes the manipulator 26 to move relative to the support structure 18 to perform a task while the support structure 18 moves and/or is at standstill.

The manipulator 26 of this example further comprises one or more torque sensors 40 and one or more force sensors 42. Each torque sensor 40 is arranged to sense a torque at an associated joint 28 and each force sensor 42 is arranged to sense a force at an associated joint 28. Each torque sensor 40 and each force sensor 42 is in signal communication with the control system 34. According to one example, the manipulator 26 comprises a torque sensor 40 at each joint 28 and one force sensor 42, e.g., at a most distal joint 28. In any case, the control system 34 may be configured to determine any force or torque acting on the manipulator 26 based on signals from the one or more torque sensors 40 and the one or more force sensors 42.

The one or more torque sensors 40 and the one or more force sensors 42 are however optional. For each trajectory of the manipulator 26 defined in the AGV control program, the resulting forces and torques can also be calculated at one or more arbitrarily chosen points of the manipulator 26 without necessarily executing the trajectory by the manipulator 26 and without using the one or more torque sensors 40 and the one or more force sensors 42. The skilled person is aware of such calculations. In this regard, reference can for example be made to WO 2022171283 A1, the content of which is incorporated in its entirety herein by reference.

The system 10 of this example further comprises a programming device 44, here exemplified as a teach pendant unit, TPU. The user 16 may create and/or modify the AGV control program using the programming device 44. In this example, the programming device 44 is configured to wirelessly communicate with the control system 34.

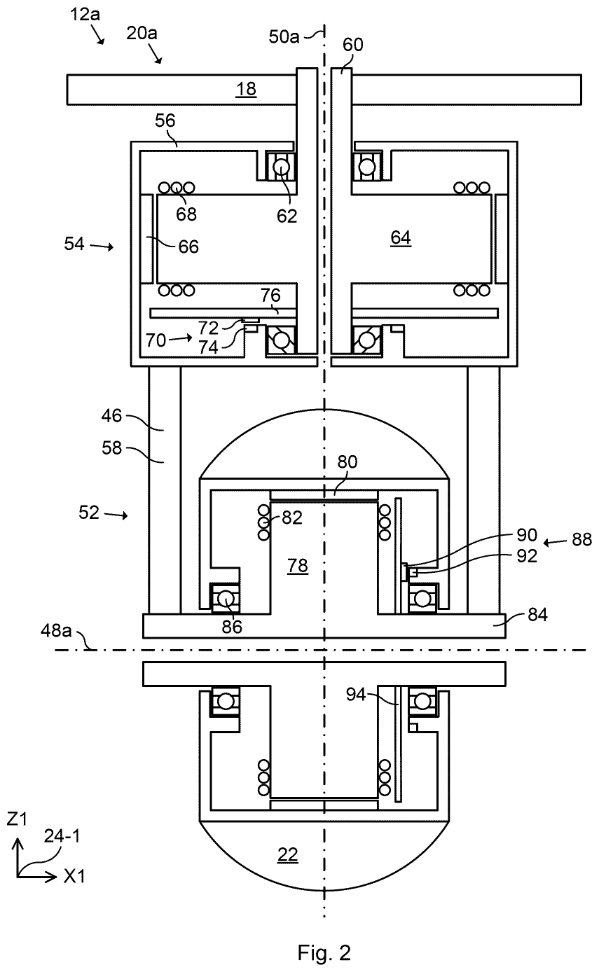

FIG. 2 schematically represents a cross-sectional view of one specific example of a wheel unit 20a for the AGV 12a. The AGV 12a is only partially illustrated in FIG. 2. The AGV 12a of this specific and non-limiting example comprises four wheel units 20a of the same design.

The wheel unit 20a of this specific and non-limiting example comprises a driven steering member 46. The wheel 22a is rotatable around a wheel axis 48a to generate a tractive force in a heading direction transverse to the wheel axis 48a. The driven steering member 46 and the wheel 22a are rotatable around a steering axis 50a. The wheel axis 48a is perpendicular to the steering axis 50a. Moreover, the wheel axis 48a intersects the steering axis 50a. In FIG. 2, the wheel axis 48a is horizontal and the steering axis 50a is vertical. The wheel axis 48a provides a first degree of freedom for the wheel unit 20a. The steering axis 50a provides a second degree of freedom for the wheel unit 20a.

The wheel unit 20a further comprises a drive motor 52, here exemplified as an electric synchronous drive motor. The drive motor 52 is arranged to rotationally drive the wheel 22a around the wheel axis 48a. In this example, the drive motor 52 is arranged to directly drive the wheel 22a, i.e. without any intermediate gearing between the drive motor 52 and the wheel 22a.

The wheel unit 20a further comprises a steering motor 54, here exemplified as an electric synchronous steering motor. The steering motor 54 is arranged to rotationally drive the driven steering member 46 around the steering axis 50a. The steering motor 54 and the drive motor 52 may for example each provide a torque of at least 5 Nm. The wheel 22a of this example is thus a steerable and drivable wheel. Since the AGV 12a of this example comprises at least two wheel units 20a, here four wheel units 20a, the AGV 12a can perform an omnidirectional motion of the support structure 18.

The steering motor 54 is arranged to directly drive the driven steering member 46, i.e. without any intermediate gearing between the steering motor 54 and the driven steering member 46. The driven steering member 46 of the example in FIG. 2 comprises a support structure part 56 and two arm parts 58 extending downwards from the support structure part 56.

The wheel unit 20a further comprises a steering shaft 60 and two steering bearings 62 for rotationally supporting the driven steering member 46 around the steering axis 50a. The steering shaft 60 is rigidly connected to the support structure 18 of the AGV 12a. The steering motor 54 comprises a steering stator 64, a steering rotor 66 and steering coils 68. The steering rotor 66 is arranged inside the support structure part 56. The steering coils 68 are arranged on the steering stator 64. In this example, the support structure part 56 is an integral part of the steering rotor 66.

The wheel unit 20a further comprises a steering sensor device 70. The steering sensor device 70 determines a rotational position of the driven steering member 46, and consequently also of the wheel 22a, around the steering axis 50a. The steering sensor device 70 is in signal communication with the control system 34. The steering sensor device 70 of this example comprises an active part, here constituted by a Hall effect steering sensor 72, and a passive part, here constituted by a multipole steering encoder ring 74.

The wheel unit 20a further comprises a steering circuit board 76. The Hall effect steering sensor 72 is provided on the steering circuit board 76. The steering encoder ring 74 is connected to the driven steering member 46.

The drive motor 52 comprises a wheel stator 78, a wheel rotor 80 and wheel coils 82. The wheel stator 78 is arranged inside the wheel 22a. The wheel coils 82 are arranged on the wheel stator 78. The wheel unit 20a further comprises a wheel shaft 84 and two wheel bearings 86 for rotationally supporting the wheel 22a around the wheel axis 48a. The wheel shaft 84 is rigidly connected to the arm parts 58 of the driven steering member 46.

The wheel unit 20a further comprises a wheel sensor device 88. The wheel sensor device 88 may be of the same type as the steering sensor device 70. The wheel sensor device 88 determines a rotational position of the wheel 22a around the wheel axis 48a. The wheel sensor device 88 is in signal communication with the control system 34. The wheel sensor device 88 of this example comprises an active part, here constituted by a Hall effect wheel sensor 90, and a passive part, here constituted by a multipole wheel encoder ring 92.

The wheel unit 20a further comprises a wheel circuit board 94. The Hall effect wheel sensor 90 is provided on the wheel circuit board 94. The wheel encoder ring 92 is connected to the wheel 22a.

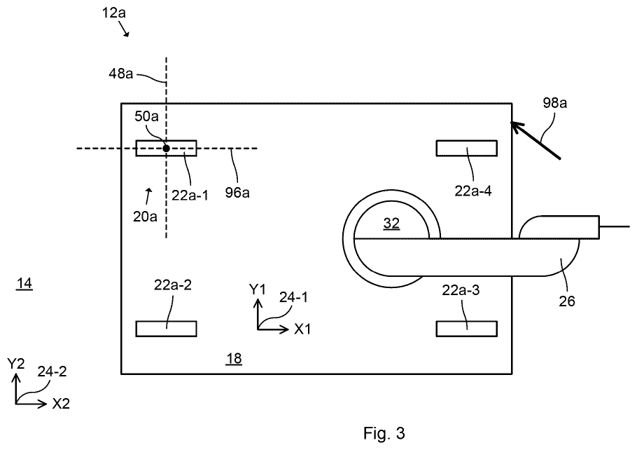

FIG. 3 schematically represents a top view of the AGV 12a. In FIG. 3, the AGV 12a is at standstill. As mentioned, the AGV 12a of this example comprises four wheel units 20a and each wheel unit 20a comprises a wheel 22a. The AGV 12a of this example thus comprises a first wheel 22a-1, a second wheel 22a-2, a third wheel 22a-3 and a fourth wheel 22a-4. One, several or all of the first wheel 22a-1, the second wheel 22a-2, the third wheel 22a-3 and the fourth wheel 22a-4 may also be referred to with reference numeral “22a” .

FIG. 3 indicates that each wheel 22a has a heading direction 96a. The X1/Y1-plane of the local coordinate system 24-1 may coincide with a plane comprising the wheel axes 48a and the heading directions 96a.

Each wheel 22a may for example be position controlled by the control system 34. When each wheel 22a is positioned controlled, a position control loop may be used where a measured position of each wheel 22a around its respective wheel axis 48a, e.g., as determined based on signals from the respective wheel sensor device 88, is fed back and compared with a respective target position. A gain of the position control loop may for example be set relatively high such that the compliance of the wheels 22a in the respective heading directions 96a is relatively small.

In FIG. 3, the wheels 22a adopts one example of a wheel configuration by virtue of the respective steering positions adopted by the wheels 22a. In this example, all wheels 22a are parallel, here parallel with the X1-direction of the local coordinate system 24-1. The wheel configuration in FIG. 3 is a valid wheel configuration.

FIG. 3 further shows one example of an application force 98a applied to the support structure 18. The application force 98a constitutes one example of an application load according to the present disclosure. The application force 98a may for example be a force applied on the support structure 18 by the user 16. The wheel configuration in FIG. 3 is not optimal for handling the application force 98a. When the application force 98a is applied to the support structure 18, there is a risk that the support structure 18 will move away from its stationary position.

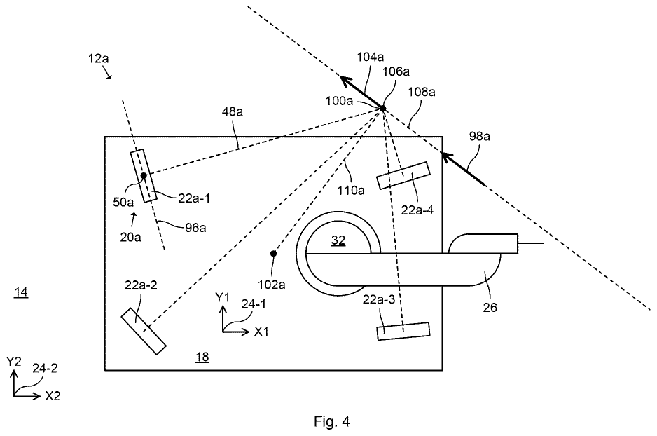

FIG. 4 schematically represents a top view of the AGV 12a. In FIG. 4, the wheels 22a adopt a further example of a wheel configuration where all wheels 22a are positioned at respective steering positions in accordance with an instant center of rotation 100a, ICR. Also in FIG. 4, the AGV 12a is at standstill.

In order to position the wheels 22a with respect to the ICR 100a, the positions of the wheels 22a in the local coordinate system 24-1 must be known. These positions of the wheels 22a may be determined in various ways known to the skilled person, including by measurements.

Also this wheel configuration is a valid wheel configuration. However, the wheel configuration in FIG. 4 provides a much higher resistance against the application force 98a than the wheel configuration in FIG. 3. In order to position the wheels 22a in a wheel configuration that provides an optimal, or near optimal stiffness of the support structure 18 with respect to the application force 98a, the following method may be performed.

A support point 102a in relation to the support structure 18 is provided in the control system 34. The support point 102a is a point in which optimal stiffness of the support structure 18 will be provided. The support point 102a may for example be defined in the X1/Y1-plane of the local coordinate system 24-1.

The support point 102a may be selected arbitrarily. For example, the user 16 may select the support point 102a. To this end, the user 16 may provide a selection of the support point 102a via the programming device 44. The selection may then be communicated from the programming device 44 to the control system 34.

Alternatively, the support point 102a may be predetermined or set automatically by the AGV control program. The support point 102a may for example be predetermined to be horizontally aligned with a geometrical center point of the support structure 18 or a geometrical center point of the wheels 22a. In FIG. 4, the support point 102a is horizontally aligned with both a geometrical center point of the support structure 18 and a geometrical center point of the wheels 22a.

The application force 98a in relation to the support structure 18 is then provided in the control system 34. To this end, the application force 98a may for example be characterized by a vector in the X1/Y1-plane of the local coordinate system 24-1. The application force 98a may be a force acting or estimated to act on the support structure 18. The application force 98a may be provided in the control system 34 in various ways.

According to one example, the application force 98a may be selected by the user 16. To this end, the user 16 may provide a selection of the application force 98a via the programming device 44. The selection may then be communicated from the programming device 44 to the control system 34.

According to a further example, the application force 98a may be determined based on the AGV control program, prior to execution of the AGV control program. In this case, the application force 98a is a force estimated to act on the support structure 18 in the future when the AGV control program is executed.

For the above two examples, the application force 98a may be associated with a particular task in the AGV control program, such as a task performed by the manipulator 26 when the support structure 18 is at standstill. Thus, when the AGV control program is executed and this particular task is performed, the control system 34 can control the wheel units 20a such that the wheels 22a adopt a wheel configuration that provides an optimal stiffness of the support structure 18 with respect to the support point 102a and the application force 98a.

According to a further example, the application force 98a may be determined based on signals from the one or more torque sensors 40, the one or more force sensors 42, the one or more of the steering sensor devices 70, and/or the one or more of the wheel sensor devices 88. In this case, the application force 98a is actually applied to the support structure 18 and the AGV 12a can react to the application force 98a by adopting a wheel configuration providing a high stiffness in the support point 102a. Moreover, in this case, the application force 98a may for example be a force originating from movements of the manipulator 26 relative to the support structure 18, a force originating from the manipulator 26 contacting an external object, and/or a force from an external part, such as the user 16, acting on the support structure 18.

For any load comprising a force acting on the support structure 18, there exists a point where this load can be represented by a pure force. In line with this, once the application force 98a has been provided, the application force 98a is represented in the control system 34 by a remote force 104a acting at a remote point 106a.

In the example in FIG. 4, the application force 98a acting on the support structure 18 provides the same torque on the support point 102a in the horizontal plane as the remote force 104a acting at the remote point 106a. The remote point 106a is thus horizontally offset from the support point 102a and acts in a horizontal remote direction 108a transverse to an offset line 110a between the support point 102a and the remote point 106a. In the example in FIG. 4, the remote direction 108a is also the direction in which the application force 98a acts. The wheel axes 48a, the heading directions 96a, the support point 102a, and the remote point 106a here lie in a common horizontal plane.

In this example, the control system 34 then controls all wheels 22a to adopt respective steering positions such that the ICR 100a coincides with the remote point 106a. To this end, the control system 34 may employ inverse kinematics to determine the respective steering positions. In this wheel configuration, the wheel axis 48a of each wheel 22a passes through the remote point 106a. This provides a wheel configuration that very efficiently resists the application force 98a and provides an optimal stiffness of the support structure 18 with respect to the support point 102a. Thus, the support structure 18 can more efficiently resist the application force 98a without being caused to move relative to the ground surface 14. As a consequence, the productivity of the manipulator 26 can be increased and the manipulator 26 can perform extra challenging manipulation tasks.

The AGV 12a may not comprise any dedicated brakes to brake the AGV 12a. Instead, the braking at standstill can be performed by various wheel configurations as described herein. In case the application load comprises only a torque, the wheels 22a may be positioned in an X-shape as taught in WO 2020259830 A1.

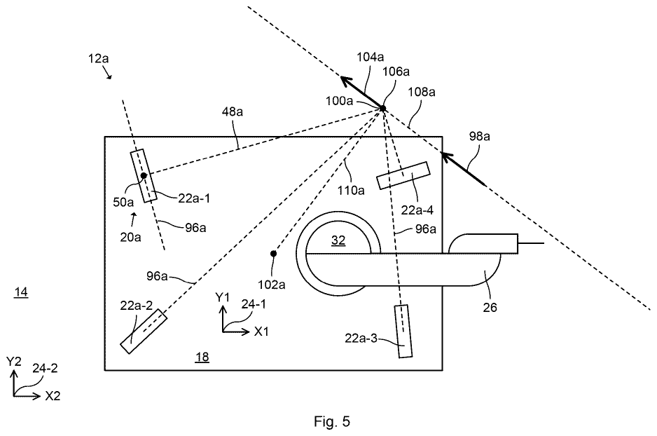

FIG. 5 schematically represents a top view of the AGV 12a. Mainly differences with respect to FIG. 4 will be described. In FIG. 5, the first and fourth wheels 22a-1 and 22a-4 are positioned at respective steering positions such that the ICR 100a of these wheels 22a coincides with the remote point 106a. The second and third wheels 22a-2 and 22a-3 on the other hand, are positioned transverse to their ICR orientation, i.e., such that their heading directions 96a intersect the ICR 100a. The wheel configuration provided by the wheels 22a in FIG. 5 is invalid. The wheel couple comprising the first and fourth wheels 22a-1 and 22a-4 spans the widest angle with respect to the remote point 106a and is therefore the couple that contributes to providing the highest stiffness in the support point 102a.

Also in this example, the AGV 12a will exhibit a stiff behavior with respect to the application force 98a. However, the positioning of the second and third wheels 22a-2 and 22a-3 provide increased stiffness in case the direction of the application force 98a should vary. The second and third wheels 22a-2 and 22a-3 thus provide redundancy to the braking of the AGV 12a. In FIG. 5, the second wheel 22a-2 is most distant from the remote point 106a. Moreover, the second and third wheels 22a-2 and 22a-3 are intermediate wheels 22a as seen from the remote point 106a. That is, as seen from the remote point 106a, the second and third wheels 22a-2 and 22a-3 lie between the first and fourth wheels 22a-1 and the 22a-4.

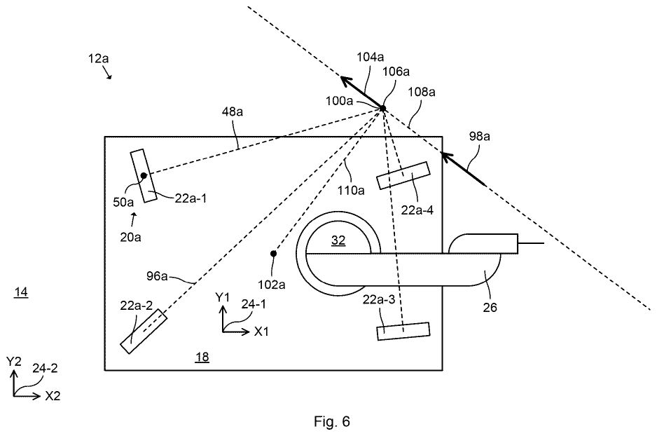

FIG. 6 schematically represents a top view of the AGV 12a. Mainly differences with respect to FIGS. 4 and 5 will be described. In FIG. 6, the first, third and fourth wheels 22a-1, 22a-3 and 22a-4 are positioned at respective steering positions such that the ICR 100a of these wheels 22a coincides with the remote point 106a. In this example, only the second wheel 22a-2 is positioned transverse to its ICR orientation, i.e., such that its heading direction 96a intersects the ICR 100a. Also the wheel configuration provided by the wheels 22a in FIG. 6 is invalid. The second wheel 22a-2 is most distanced from the remote point 106a. The second wheel 22a-2 is also an intermediate wheel with respect to the first and third wheels 22a-1 and 22a-3 as seen from the remote point 106a. Also in this example, the AGV 12a will exhibit a stiff behavior with respect to the application force 98a. Moreover, the positioning of the second wheel 22a-2 provides increased stiffness in case the direction of the application force 98a should vary.

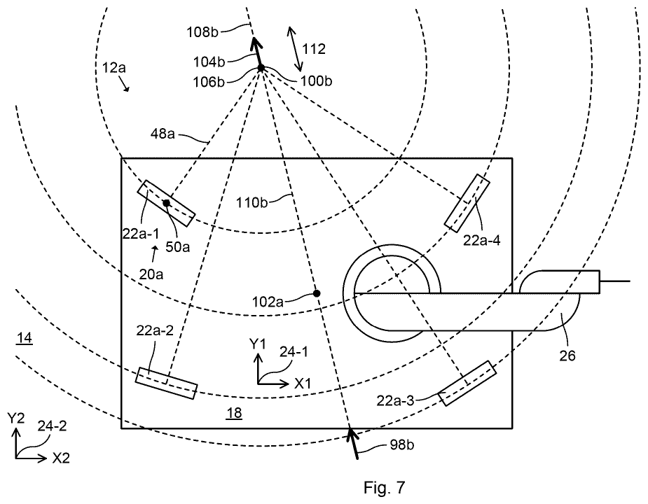

FIG. 7 schematically represents a top view of the AGV 12a and an application force 98b acting on the support structure 18. The application force 98b is a further example of an application load according to the present disclosure. FIG. 7 shows a special case when the application force 98b acts along a line passing through the support point 102a. The application force 98b does therefore not cause any torque at the support point 102a. When the application force 98b is represented by remote force 104b, acting at a remote point 106b horizontally offset from the support point 102a and acting in a horizontal remote direction 108b, the remote direction 108b will also pass through the support point 102a. In this case, the remote point 106b may be positioned anywhere along the remote direction 108b, as shown with arrow 112. As the distance between the support point 102a and the remote point 106b increases, the stiffness will increase, but the resistance against variations in the direction of the application force 98b will be decreased, and vice versa. In these cases, the distance between the support point 102a and the remote point 106b may for example be preset to a distance larger than a smallest distance between two of the wheels 22a and smaller than a largest distance between two of the wheels 22a, such as to an average distance of these two distances.

In any case, each wheel 22a is positioned at a respective steering position such that an ICR 100b of these wheels 22a coincides with the remote point 106b. This provides the wheel configuration shown in FIG. 7, which is a valid wheel configuration. Also in this example, the AGV 12a will exhibit a stiff behavior with respect to the application force 98b.

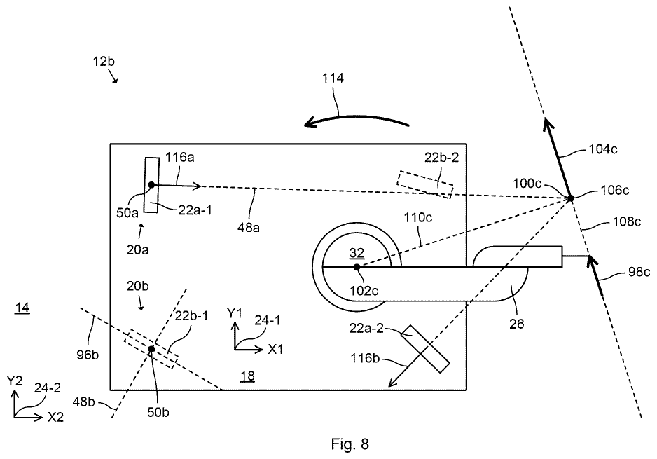

FIG. 8 schematically represents a top view of an AGV 12b according to a further example. The system 10 in FIG. 1 may alternatively comprise the AGV 12b. The AGV 12b of this example comprises two wheel units 20a of the type shown in FIG. 2. The AGV 12b thus comprises a first wheel 22a-1 and a second wheel 22a-2.

The AGV 12b of this example further comprises a first wheel 22b-1 and a second wheel 22b-2, here exemplified as swivel casters. A swivel caster is one example of a non-driven wheel. One or both wheels 22b-1 and 22b-2 may also be referred to with reference numeral “22b”. Although being non-drivable, each wheel 22b of this example comprises a heading direction 96b and is rotatable around a wheel axis 48b and around a steering axis 50b.

FIG. 8 further shows an application force 98c and a torque 114. The application force 98c and the torque 114 collectively constitute a further example of an application load according to the present disclosure. The application force 98c is here exemplified as a force acting on the manipulator 26. The torque 114 is here exemplified as a reaction torque acting on the first link 32 of the manipulator 26 due to a rotation of the first link 32 relative to the support structure 18 in the clockwise direction in FIG. 8.

FIG. 8 shows a further example of a support point 102b. The support point 102b of this example is centered with respect to the first link 32, here horizontally offset from a geometrical center point of the support structure 18. Thus, optimal stiffness will be provided in the first link 32.

In accordance with the method the support point 102b is provided in the control system 34, e.g., selected by the user 16 or by the control system 34. The application load comprising the application force 98c and the torque 114 in relation to the support structure 18 is then provided in the control system 34, e.g., by a selection from the user 16, by a determination based on the AGV control program prior to execution of the AGV control program, or based on calculations of signals from the one or more torque sensors 40, the one or more force sensors 42, the one or more of the steering sensor devices 70, and/or the one or more of the wheel sensor devices 88.

Furthermore, the application load is represented by a remote force 104c acting at a remote point 106c horizontally offset from the support point 102c, and acting in a horizontal remote direction 108c transverse to an offset line 110c between the support point 102b and the remote point 106c. As can be gathered from FIG. 8, the remote force 104c provides the same torque around the support point 102c as the application force 98c and the torque 114 in combination. A magnitude of the remote force 104c is thus larger than a magnitude of the application force 98c.

All wheels 22a are then controlled to be positioned at a respective steering position such that an ICR 100c of these wheels 22a coincides with the remote point 106c. Optimal stiffness is thus provided at the center of the first link 32. Since the wheels 22b are not steerable, these wheels are positioned at random steering positions. In FIG. 8, the wheels 22a and 22b provide a further example of a wheel configuration, which is an invalid wheel configuration.

As illustrated in FIG. 8, the remote force 104c is in equilibrium with a first side force 116a of the first wheel 22a-1 and a second side force 116b of the second wheel 22a-2. The first and second side forces 116a and 116b act only in parallel with the respective wheel axis 48a and only transverse to the respective heading directions 96a. Consequently, there will not be any torque applied on the drive motors 52 as a result of the application load. For the case in FIG. 8 where the AGV 12b only comprises two steerable wheels 22a, the method according to the present disclosure is particularly advantageous.

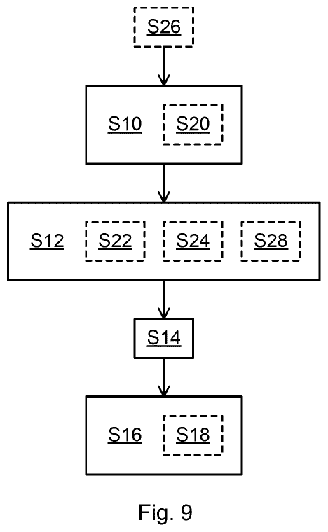

FIG. 9 is a flowchart outlining general steps of a method of controlling an automated guided vehicle 12a; 12b, AGV. The AGV 12a; 12b comprises a support structure 18 and at least three wheel units 20a; 20b, each wheel unit 20a; 20b comprising a wheel 22a; 22b rotatable around a horizontal wheel axis 48a; 48b. For at least two of the wheel units 20a, the wheel unit 20a comprises a steering motor 54 arranged to drive the wheel 22a around a vertical steering axis 50a.

The method comprises providing S10 a support point 102a; 102b in relation to the support structure 18. The method further comprises providing S12 an application load in relation to the support structure 18, the application load comprising an application force 98a; 98c. The method further comprises representing S14 the application load by a remote force 104a; 104c acting at a remote point 106a; 106c horizontally offset from the support point 102a; 102b, and acting in a horizontal remote direction 108a; 108c transverse to an offset line 110a; 110c between the support point 102a; 102b and the remote point 106a; 106c. The method further comprises for the at least two of the wheel units 20a comprising a steering motor 54, positioning S16 each wheel 22a in a steering position such that an instant center of rotation 100a; 100c, ICR, of each wheel 22a substantially coincides with the remote point 106a; 106c.

For at least three of the wheel units 20a, the wheel unit 20a may comprise a steering motor 54 arranged to drive the wheel 22a around a vertical steering axis 50a. In these cases, the method may further comprise for at least one of the wheel units 20a comprising a steering motor 54, positioning S18 the wheel 22a of the wheel unit 20a in a steering position such that a heading direction 96a of the wheel 22a is substantially transverse to the remote direction 108a; 108c.

The provision S10 of the support point 102a; 102b may comprise receiving S20, from a user 16 via a programming device 44, a selection of the support point 102a; 102b.

The provision S12 of the application load may comprise receiving S22, from a user 16 via a programming device 44, a selection of the application load.

The provision S12 of the application load may comprise determining S24, by the AGV 12a; 12b using one or more sensors 40, 42, 70, 88 of the AGV 12a; 12b, the application load.

The method may further comprise providing S26 an AGV control program comprising at least one movement instruction for the AGV 12a; 12b. In these cases, the provision S12 of the application load may comprise determining S28 the application load based on the AGV control program.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

In the context of the present disclosure, the steering positions adopted by the respective wheels are said to form a wheel configuration. The wheel configuration according to the method enables an increased stiffness of the support structure with respect to the application load. Since the application load is represented by the remote force acting in the remote direction, the remote direction may be said to be a prioritized direction in which the support structure has an optimally high, or near optimally high, stiffness. The method thus provides a wheel configuration that is adapted to the application load.

Due to the increased stiffness of the support structure provided by the method, the performance of the AGV is improved. The method ensures that any known application load comprising an application force translates to pure side-to-side forces, i.e., in the respective directions of the wheel axes, of the wheels positioned in the respective steering positions to provide the ICR. The positioning of the wheels in the respective steering positions in accordance with the ICR provides a kinematic locking of the wheels and hence a braking of the AGV.

Each wheel is configured to support the support structure on a horizontal ground surface, such as a floor. With stiffness of the support structure is meant the ability of the support structure to resist loads acting horizontally on the support structure without the support structure being caused to move horizontally relative to the ground surface.

The wheel configuration provided by the method may not provide the highest stiffness for an application force acting in any direction. However, for an application force acting in the remote direction, the wheel configuration will provide an optimal, or near optimal, stiffness.

With two or more wheels adopting steering positions to provide an ICR is meant that the wheel axes of these wheels intersect the ICR. For two non-parallel wheels, an ICR will always be provided. For two parallel wheels, the ICR will be infinitely far away from the AGV.

One, several or all of the at least two wheel units comprising a steering motor may also comprise a drive motor arranged to drive the wheel around the wheel axis. In these cases, the positioning of these wheels such that the ICR coincides with the remote point will ensure that the application load does not generate any torque, or any significant torque, on such drive motors. With the ICR substantially coinciding with the remote point may be meant that a maximum distance between the ICR and the remote point is less than 10%, such as less than 5% of a maximum distance between the remote point and one of the wheels.

The AGV may optionally comprise a manipulator. The manipulator may be a robot arm programmable in three or more axes, such as in six or seven axes. The manipulator may be supported on the support structure and movable relative to the support structure. When the AGV comprising the manipulator is at standstill, the support structure is in a stationary position, but the manipulator may move relative to the support structure. The AGV may for example be an autonomous mobile robot, AMR, or an autonomous mobile manipulator robot, AMMR, comprising the manipulator.

Particularly in cases where the AGV comprises the manipulator, the increased stiffness of the support structure provided by the method increases the productivity of the AGV. The increased stiffness of the support structure provided by the method enables the manipulator to perform more advanced tasks, enables the manipulator to perform tasks at higher speeds, enables a reduced or eliminated need for recalibrating the AGV, and enables interactions or more advanced interactions with external objects.

When the manipulator performs a first task that generates a first application load, the wheels of at least two wheel units comprising a steering motor may be positioned in a first wheel configuration in accordance with the method. When the manipulator performs a second task that generates a second application load, different from the first application load, the wheels of at least two wheel units comprising a steering motor may be positioned in a second wheel configuration, different from the first wheel configuration, in accordance with the method. In this way, a time series of different wheel configurations may be provided to provide an optimal stiffness for each task performed by the manipulator. This implies that the support structure may remain at standstill while the manipulator performs several tasks, but at least two of the wheels may rotate around their respective steering axis after completion of each task to provide optimal stiffness for the next task.

The support structure may be a platform. The method according to the first aspect may be performed when the support structure is at standstill.

The method may provide the highest stiffness in the support point. The support point may be selected arbitrarily. The support point may be predefined, may be selected by a control system of the AGV or may be selected by a human user. In any case, the support point may be provided in the control system, either directly or indirectly based on a user input.

The application load may be a load acting or estimated to act on the support structure. Correspondingly, the application force may be a force acting or estimated to act on the support structure. In addition to the application force, the application load may comprise a torque. The torque may be a torque acting or estimated to act on the support structure. In any case, characteristics of the application load, such as one or more vectors thereof in a horizontal plane, may be provided by the control system or online. The representation of the application force by the remote force may be performed by the control system or online.

The steering positions of the at least two wheel units comprising a steering motor may be calculated by inverse kinematics, for example based on a position of the support point, a position of the remote point and a position of the respective wheel unit in a local coordinate system fixed with respect to the support structure. Such calculations may be made by the control system or online. The positioning of the wheels in the respective steering position may be controlled by the control system.

The wheel configuration adopted by the wheels in the method may be either a valid or an invalid wheel configuration. Invalid wheel configurations include all configurations of the wheels except valid configurations. Valid wheel configurations include only an orientation of all the wheels in parallel and an orientation of all the wheels to provide an ICR.

Two, several or all the wheel units may comprise a steering motor arranged to drive the wheel around a vertical steering axis. The method may comprise for all of the wheel units comprising a steering motor, positioning each wheel in a steering position such that an instant center of rotation, ICR, of each wheel substantially coincides with, or coincides with, the remote point. In addition to the at least two steerable wheels, the AGV may comprise one or more non-driven wheels, such as swivel casters or other passive wheels.

The wordings “application load” and “application force” are selected since the application load comprises the application force and since the application force may differ from the remote force representing the application load. The application load, the application force and the remote force may alternatively be referred to as a primary load, a primary force and a secondary force, respectively.

For at least three of the wheel units, the wheel unit may comprise a steering motor arranged to drive the wheel around a vertical steering axis. In these cases, the method may further comprise for at least one of the wheel units comprising a steering motor, positioning the wheel of the wheel unit in a steering position such that a heading direction of the wheel is substantially transverse to, or transverse to, the remote direction. Thus, in cases where more than two steerable wheel units are available, at least one of the wheels may be positioned in this manner. In this way, an increased robustness against variations of a direction of the application force is provided.

The at least one of the wheel units comprising a steering motor may be an intermediate wheel unit as seen from the remote point. Thus, the two wheels creating the widest span towards the remote point may be oriented such that these wheels provide an ICR coinciding with the remote point, while a third intermediate wheel is positioned such that its heading direction is substantially transverse to, or transverse to, the remote direction. Alternatively, or in addition, the at least one of the wheel units comprising a steering motor may be a wheel unit most distant from the remote point.

The provision of the support point may comprise receiving, from a user via a programming device, a selection of the support point. The provision of the application load may comprise receiving, from a user via a programming device, a selection of the application load. The programming device may for example be a teach pendant unit, TPU. The one or more selections by the user may be communicated wirelessly or via a control cable to the control system of the AGV.

The provision of the application load may comprise determining, by the AGV using one or more sensors of the AGV, the application load. The application load may thus for example originate from execution of an AGV control program. In this case, the application load is a load acting on the AGV. Examples of such loads comprise loads originating from the AGV interacting with its environment, e.g., physically contacting an object, and loads originating from movements of a manipulator of the AGV relative to the support structure. In any case, such application loads can be determined by the one or more sensors of the AGV.

The method may further comprise providing an AGV control program comprising at least one movement instruction for the AGV. In these cases, the provision of the application load may comprise determining the application load based on the AGV control program. The application load may originate from the AGV control program as such, e.g., prior to execution of the AGV control program. In this case, the application load is a load estimated to act on the support structure when the AGV control program is executed.

The application load may however comprise a force or a torque that does not necessarily originate from the AGV control program or from an execution of the AGV control program, such as a force or a torque originating from a human pushing the AGV and which can be sensed by the one or more sensors of the AGV.

According to a second aspect, there is provided an automated guided vehicle, AGV, the AGV comprising a support structure; at least three wheel units, each wheel unit comprising a wheel rotatable around a horizontal wheel axis, wherein for at least two of the wheel units, the wheel unit comprises a steering motor arranged to drive the wheel around a vertical steering axis; and a control system comprising at least one data processing device and at least one memory having at least one computer program stored thereon, the at least one computer program comprising program code which, when executed by the at least one data processing device, causes the at least one data processing device to provide a support point in relation to the support structure; provide an application load in relation to the support structure, the application load comprising an application force; represent the application load by a remote force acting at a remote point horizontally offset from the support point, and acting in a horizontal remote direction transverse to an offset line between the support point and the remote point; and for the at least two of the wheel units comprising a steering motor, command positioning of each wheel in a steering position such that an instant center of rotation, ICR, of each wheel substantially coincides with, or coincides with, the remote point. The AGV of the second aspect may be of any type described in connection with the first aspect, and vice versa.

For at least three of the wheel units, the wheel unit may comprise a steering motor arranged to drive the wheel around a vertical steering axis. In these cases, the at least one computer program may comprise program code which, when executed by the at least one data processing device, causes the at least one data processing device to, for at least one of the wheel units comprising a steering motor, command positioning of the wheel of the wheel unit in a steering position such that a heading direction of the wheel is transverse to the remote direction.

The at least one of the wheel units comprising a steering motor may be an intermediate wheel unit as seen from the remote point.

The at least one of the wheel units comprising a steering motor may be a wheel unit most distant from the remote point.

The provision of the support point may comprise receiving, from a user via a programming device, a selection of the support point.

The provision of the application load may comprise receiving, from a user via a programming device, a selection of the application load.

The AGV may comprise one or more sensors. In these cases, the provision of the application load may comprise determining, by the control system and based on data from the one or more sensors, the application load.

The at least one computer program may comprise program code which, when executed by the at least one data processing device, causes the at least one data processing device to provide an AGV control program comprising at least one movement instruction for the AGV. In these cases, the provision of the application load may comprise determining the application load based on the AGV control program.

According to a third aspect, there is provided a system comprising the AGV according to the second aspect and a programming device configured to be in signal communication with the control system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of controlling an automated guided vehicle (AGV), the AGV comprising a support structure and at least three wheel units, each of the at least three wheel units comprising a wheel rotatable around a horizontal wheel axis, wherein for at least two of the at least three wheel units, the respective wheel unit comprises a steering motor arranged to drive the wheel around a vertical steering axis; wherein the method comprises:
providing a support point in relation to the support structure;
providing an application load in relation to the support structure, the application load comprising an application force;
representing the application load by a remote force acting at a remote point horizontally offset from the support point, and acting in a horizontal remote direction transverse to an offset line between the support point and the remote point; and
for the at least two of the at least three wheel units comprising a steering motor, positioning each wheel in a steering position such that an instant center of rotation (ICR) of each wheel substantially coincides with the remote point.

2. The method according to claim 1, wherein for at least three of the wheel units, the wheel unit comprises a steering motor arranged to drive the wheel around a vertical steering axis; and wherein the method further comprises for at least one of the wheel units comprising a steering motor, positioning the wheel of the wheel unit in a steering position such that a heading direction of the wheel is substantially transverse to the remote direction.

3. The method according to claim 2, wherein the at least one of the wheel units comprising a steering motor is an intermediate wheel unit as seen from the remote point.

4. The method according to claim 2, wherein the at least one of the wheel units comprising a steering motor is a wheel unit most distant from the remote point.

5. The method according to claim 1, wherein provision of the support point comprises receiving, from a user via a programming device, a selection of the support point.

6. The method according to claim 1, wherein the provision of the application load comprises receiving, from a user via a programming device, a selection of the application load.

7. The method according to claim 1, wherein provision of the application load comprises determining, by the AGV using one or more sensors of the AGV, the application load.

8. The method according to claim 1, further comprising providing an AGV control program comprising at least one movement instruction for the AGV, wherein the provision of the application load comprises determining the application load based on the AGV control program.

9. An automated guided vehicle (AGV), comprising:
a support structure;
at least three wheel units, each of the at least three wheel units comprising a wheel rotatable around a horizontal wheel axis, wherein at least two of the wheel units include a steering motor arranged to drive the wheel around a vertical steering axis; and
a control system comprising at least one data processing device and at least one memory having at least one computer program stored thereon, the at least one computer program comprising program code which, when executed by the at least one data processing device, causes the at least one data processing device to:
provide a support point in relation to the support structure;
provide an application load in relation to the support structure, the application load comprising an application force;
represent the application load by a remote force acting at a remote point horizontally offset from the support point, and acting in a horizontal remote direction transverse to an offset line between the support point and the remote point; and
for the at least two of the wheel units comprising a steering motor, command positioning of each wheel in a steering position such that an instant center of rotation (ICR) of each wheel substantially coincides with the remote point.

10. The AGV according to claim 9, wherein for at least three of the wheel units, the wheel unit comprises a steering motor arranged to drive the wheel around a vertical steering axis; and wherein the at least one computer program comprises program code which, when executed by the at least one data processing device, causes the at least one data processing device to, for at least one of the wheel units comprising a steering motor, command positioning of the wheel of the wheel unit in a steering position such that a heading direction of the wheel is transverse to the remote direction.

11. The AGV according to claim 10, wherein the at least one of the wheel units comprising a steering motor is an intermediate wheel unit as seen from the remote point.

12. The AGV according to claim 11, wherein the at least one of the wheel units comprising a steering motor is a wheel unit most distant from the remote point.

13. The AGV according to claim 9, wherein the provision of the support point comprises receiving, from a user via a programming device, a selection of the support point.

14. The AGV according to claim 9, wherein the provision of the application load comprises receiving, from a user via a programming device, a selection of the application load.

15. The AGV according to claim 9, wherein the AGV comprises one or more sensors, and wherein the provision of the application load comprises determining, by the control system and based on data from the one or more sensors, the application load.

16. The AGV according to claims 9, wherein the at least one computer program comprises program code which, when executed by the at least one data processing device, causes the at least one data processing device to provide an AGV control program comprising at least one movement instruction for the AGV, wherein the provision of the application load comprises determining the application load based on the AGV control program.

17. The AGV of claim 9, further comprising a programming device associated with the AGV, the programming device configured to be in signal communication with the control system.
